(19) United States
(12) Patent Application Publication
(10) Pub. No.: US 2021/0382200 A1
(43) Pub. Date: Dec. 9, 2021

(54) POSITIONING FOR WEATHER SENSING DEVICES

(71) Applicant: Weather Intelligence Technology, Inc., Burlingame, CA (US)

(72) Inventors: Simeng Yan, Burlingame, CA (US); Wenxiu Sun, Redwood City, CA (US)

(21) Appl. No.: 16/896,174

(22) Filed: Jun. 8, 2020

(51) Int. Cl. G01W 1/18; G01W 1/04; G01W 1/10

(52) U.S. Cl. CPC G01W 1/18; G01W 1/10; G01W 1/04

(57) ABSTRACT

In various embodiments, information regarding weather sensing devices in an observation network can be collected. Value differences such as root-mean-square errors (RMSEs) can then be calculated for values of a weather variable based on the collected information. A relationship between the value differences and distances among the weather sensing devices can be determined. A pre-determined value difference for the weather variable such as a pre-determined RMSE for the weather variable can be obtained. A distance for positioning two weather sensing devices in the observation network can be determined based on the relationship and the pre-determined value difference. One or more instructions may be issued based on the determined distance for a configuration of the observation network.

### FIELD OF THE INVENTION

The invention generally relates to positioning of weather sensing devices.

### BACKGROUND OF THE INVENTION

Weather is the present condition of the atmosphere over a given place and time, measured in terms of variables including precipitation, temperature, wind speed and direction and humidity among others. Weather can change over a short period of time such as hours and days. In the past, weather patterns were easily predictable based on indigenous knowledge e.g. one would tell in which months of the year rains were expected for a given place. Such methods of weather prediction have become unreliable. That is, the rains come when they are least expected.

Traditional weather forecasting typically relies on sophisticated weather models and data obtained through specialized equipment, such as weather satellites, large ground weather stations equipped with telescopes and large cameras, and the like. Traditional weather forecasting puts constraints on a granularity of a forecast report provided. The report typically will have to cover relatively wide-spread area such as a county, a city, or a zip code, due to the costs and sparsity of the traditional weather forecasting service providers. For example, it is nearly commercially unattainable for a traditional weather forecasting service to provide localized forecasting only focusing on a small area—for example for a crop field no more than 10 acres.

An automatic weather station (AWS) is an automated version of the traditional weather station, either to save human labor or to enable measurements from remote areas. An AWS will typically consist of a weather-proof enclosure containing the data logger, rechargeable battery, telemetry (optional) and the meteorological sensors with an attached solar panel or wind turbine and mounted upon a mast. The specific configuration may vary due to the purpose of the system. The system may report in near real time via the Argos System and the Global Telecommunications System, or save the data for later recovery.

Sensor network (SN) refers to a group of spatially dispersed and dedicated sensors for monitoring and recording the physical conditions of the environment and organizing the collected data at a central location. SNs measure environmental conditions like temperature, sound, pollution levels, humidity, wind, and so on.

### SUMMARY OF THE INVENTION

One general aspect includes a method for determining a configuration of the observation network including weather sensing devices. The method may be implemented by a processor configured to execute machine-readable instructions. The method may include: collecting information regarding the weather sensing devices. The method may also include calculating value differences for a weather variable based on the collected information. The method may include determining a relationship between the value differences and distances among the weather sensing devices. The method may include obtaining a value difference for the weather variable according to one or more factors relating to a purpose or goal for positioning weather devices in the observation network. The method may include determining a desirable distance for positioning two weather sensing devices in the observation network based on the relationship between the calculated value differences and the pre-determined value difference. One or more instructions may be issued based on desirable distance for the configuration of the observation network. Other embodiments of this aspect include corresponding computer systems, apparatus, and computer programs recorded on one or more computer storage devices, each configured to perform the actions of the methods.

In various embodiments: the weather variable may include one of the following: temperature, humidity, pressure, or wind speed. In various embodiments, root mean-square errors can be determined based on various values of the weather variable collected by the weather station. In those embodiments, the RMSEs can be fit to a curve line and a coefficient for the curve line can be determined. Based on the coefficient, a positioning distance between two weather sensing devices in the observation network can be obtained based on a pre-determined RMSE. In various embodiments, implementations of the described techniques may include hardware, a method or process, or computer software on a computer-accessible medium.

Other objects and advantages of the invention will be apparent to those skilled in the art based on the following drawings and detailed description.

### BRIEF DESCRIPTION OF THE DRAWINGS

FIG. 1 illustrates an example of a system configured to facilitate position of weather sensing device in accordance with the disclosure.

FIG. 2 illustrates one example of an observed RMSE for average wind speed between two weather sensing devices with respect to distances between the two weather sensing devices.

FIG. 3 shows an example of observing clouds using two cameras onboard two weather sensing devices.

FIG. 4 illustrates an example method for determining a desirable distance between two weather sensing devices in an observation network in accordance with the disclosure.

FIG. 5 illustrates another example method for determining a desirable distance between two weather sensing devices in an observation network in accordance with the disclosure.

FIG. 6 illustrates still another example method for determining a desirable distance between two weather sensing devices in an observation network in accordance with the disclosure.

FIG. 7 illustrates one example for the server shown in FIG. 1.

FIG. 8 illustrates an example of an application scenario of an optimal distance determined for positioning weather sensing devices in an observation network in accordance with the disclosure.

FIG. 9 illustrates another example of an application scenario of an optimal distance determined for positioning weather sensing devices in an observation network in accordance with the disclosure

FIG. 10 illustrates a simplified computer system that can be used to implement various embodiments described and illustrated herein.

### DETAILED DESCRIPTION

An automated weather station (AWS) is a type of a weather sensing device which contains sensors to measure the atmosphere variables such as temperature, humidity, pressure, wind, rainfall, air quality. The new generation of automated weather stations also typically includes a high definition camera which captures the cloud or some weather phenomenon to be fed into image processing learning algorithms for weather forecast.

As weather sensing devices such as AWSs have become more wide-spread in use on fields, positioning of AWS on the fields have garnered some attention. The challenge is how to position the AWSs to optimize their capture of information. If two weather sensing devices are positioned too closely, they essentially provide information of not much difference for weather prediction and/or monitoring. If two weather sensing devices are positioned too far apart, they, on the other hand, will provide information having gaps in between, which may result in inaccurate weather prediction and/or monitoring.

In some instances, positioning weather sensing devices within distances close to each other heuristically may achieve a balance between coverage and accuracy. For example, as a rule of thumb, a service provider may instruct an operator of a field to position the weather sensing devices 500 meters away from each other in the entire field. In that case, even though some information captured by the weather sensing devices may overlap, the information captured nevertheless covers the entire field and thus is good enough for weather prediction and/monitoring. However, such a solution does not scale well. While it may work in a relatively small field, it may not work well in a large field. Take a field of a forest for example, such a field may span over tens of thousands of acres, simply positioning the weather sensing devices heuristically in distances may not work well.

Besides spacing between two weather sensing devices, other considerations for positioning weather sensing devices may include avoiding obstacle object(s) nearby, positioning the weather sensing devices at different heights in a complex topology, position angle of each AWS and etc. If positioned optimally, the weather sensing devices can form a weather observation network that can cover an entire field of interest to provide help information for more accurate weather prediction and/or monitoring.

One motivation behind the present disclosure is to facilitate optimal positioning of weather sensing devices in a field of interest. In some embodiments, location and/or area information regarding a field of interest may be provided to a weather sensing device positioning system. The positioning system may process the location and/or are information; and obtain positions of weather sensing devices to be installed in the field of interest for optimal weather prediction and/or monitoring.

### Example System

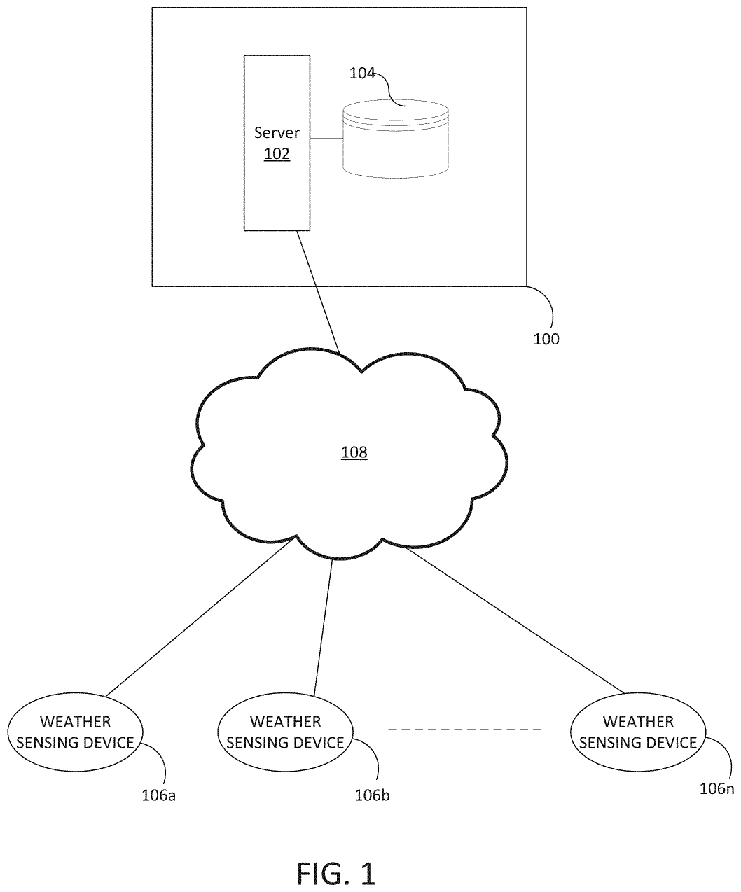

FIG. 1 illustrates one example of a system 100 to facilitate positioning of a weather sensing device in accordance with the disclosure. As shown, the system 100 may include a server 102 and a database 104, and may be communicatively connected with a network 108, such as the Internet. In operations, the system 100 may communicate with weather sensing devices such as weather stations 106a-n shown in this example via the network 108.

The weather sensing devices 106a-n may provide various weather information regarding field of interest to the system 100. For example, the weather sensing device 106a may be associated with a first field of interest (such as a portion of a forest). Weather information such as temperature, humidity, pressure, wind, and rainfall regarding the first field of interest, location information such as size of the first field of interest, various terrain information regarding the first field of interest and any other information that can collected by weather sensing device 106a may be provided by the client device 106a. In one implementation, the weather sensing device 106a may provide one or more images regarding the first field of interest to the system 100, which can process the images to extract various location and/or area information regarding the first field of interest. Such information may be stored by the system 100, for example, at database 104.

In some embodiments, the system 100 may be provided by a weather service provider. In those embodiments, the system 100 can be configured to provide various suggested configurations of weather sensing devices on the field of interest based on information received from the devices 106a-n. Take the aforementioned first field of interest for an example, after the system 100 receives the monitored weather information regarding the first field of interest from the devices 106a-n, the system 100 may determine positioning of the devices 106 to be installed in the first field of interest for optimal weather prediction and/or monitoring for the first field of interest. Such positioning determined by the system 100 may include determining distances between the devices 106, density of the devices 106, installation height of the devices 106, installation angles of the devices 106, various internal settings (such as capture frequencies and capture qualities) for the individual the devices 106, and/or any other settings for the devices to be installed in the first field of interest.

It should be understood one objective of the system 100 is to determine positioning of devices 106 not only currently installed on the first field of interest, but also those devices that will be installed on the first field of interest. For example, after the 5 devices 106 are initially installed on the first field of interest, system 100 starts to collect weather information from those devices and determine one or more desirable device positioning. For instance, in that example the system 100 may determine 10 devices should be installed on the field of interest in a specific configuration based on the data collected from the 5 devices currently installed on the first field of interest.

In researching determining optimal positioning of weather sensing devices in field of interest, the inventor(s) have come across the following insights: 1) weather observation should be representative of the adjacent air; 2) the time series of temperature, humidity, pressure, humidity, wind and rainfall from two weather sensing devices should be different enough to indicate the characteristics of the air each observed is not homogenous; and 3) weather sensing devices with high resolution camera to capture sky/weather phenomena images (e.g. produced by Weather Intelligence Technology) has an image plane coverage based on the objects that the camera is facing.

Many previous studies have been performed in automated weather station network design. One of the utmost questions to be answered is how close the two adjacent weather stations should be. Some of the previous studies have examined automated weather station networks design considering the error of extrapolation. The underlying assumption is that the extrapolation error should not exceed the observation error. Based on that, the appropriate distance between the weather stations can be calculated. Some other efforts use the partial correlation coefficient as the criteria for deciding whether another weather station is needed.

### Determining Density for a Weather Sensing Device Network Based on Difference Between the Weather Variables Observed

One insight provided by the inventor(s) is a contribution to solving the aforementioned weather positioning by calculating value differences collected by various weather sensing devices already positioned on one or more fields. These calculated value differences can then be fitted through a curve to estimate a relationship between distances among the weather devices and the value differences. Based on one or more factors relating to the observation network, such as a design choice, one or more principles of agriculture technologies, one or more purpose of the observation network, and/or any other factors, a value difference for the values of the weather variable to be collected weather sensing devices positioned in the observation network can be obtained.

A positioning distance between two weather sensing devices in the observation network can then be obtained by mapping the predetermined value difference for the weather variable to the positioning distance according to the aforementioned relationship. In this way, flexibility for positioning weather sensing devices in the observation network can be achieved. For example, predicting weather for a field that yields crops can require very different positioning of weather sensing devices than monitoring a field for potential flooding. Thus, the predetermined value difference for the weather sensing devices can be used to obtain optimal weather sensing device positioning for different observation networks.

In some embodiments, the value differences for the weather variable can be obtained through statistical analysis on values for the weather variable collected by the weather sensing devices, such as the root-mean-square deviation (RMSD) or root-mean-square error (RMSE). RMSE is a frequently used measure of the differences between values (sample or population values) predicted by a model or an estimator and the values observed. The RMSE represents the square root of the second sample moment of the differences between predicted values and observed values or the quadratic mean of these differences. These deviations are called residuals when the calculations are performed over the data sample that was used for estimation and are called errors (or prediction errors) when computed out-of-sample. The RMSE serves to aggregate the magnitudes of the errors in predictions for various times into a single measure of predictive power. RMSE is a measure of accuracy, to compare forecasting errors of different models for a particular dataset and not between datasets, as it is scale-dependent.

In determining a density for positioning the weather sensing devices, inventor(s) came to an insight to use a different framework to frame the problem compared to the previous studies mentioned above. In this novel framework, RMSE is used to measure a difference between time series of the weather variables (e.g., temperature, humidity, pressure, wind etc.) from two weather sensing devices. The RMSE varies with distance variations between the weather sensing devices. It is observed that RMSE and distance between two weather stations may be assumed to follow the following relationship described in Eq. 1

e=α×d^{β} Eq. 1

In Eq. 1 above, RMSE is represented as e and the distance represented as d. α is coefficient. Eq. 1 means when d is zero: the two weather sensing devices are right adjacent to each other, the error measured by RMSE should be zero with no observation error; and when d increases, the RMSE should be larger hence α should be larger than 0.

With this equation, data from weather sensing devices can be used to calculate the error with relationship to distances between the weather sensing devices; and statistical learning methods can be applied to fit equation 1 to determine α and β. In this process, it then comes to the question about what the error can be such that two time series are different enough that the weather variables relating to the air mass are not considered homogeneous. The inventor(s) have found that in different application scenarios a desirable threshold of the error for determining the two time series of the weather variables may be different. For example, for temperature, if the error between two weather sensing devices exceeds 1 Celsius, it may be reasonable to put another weather sensing device in the distance d where the error is identified according to Eq. 1. In some embodiments, Eq. 1 can be applied to each of the weather variables in time series collected weather sensing devices. In those embodiments, a desired distance of each two adjacent weather sensing devices based on an error threshold we choose for each weather variable to generate a reasonably complete picture of the atmosphere conditions over the whole area of interest.

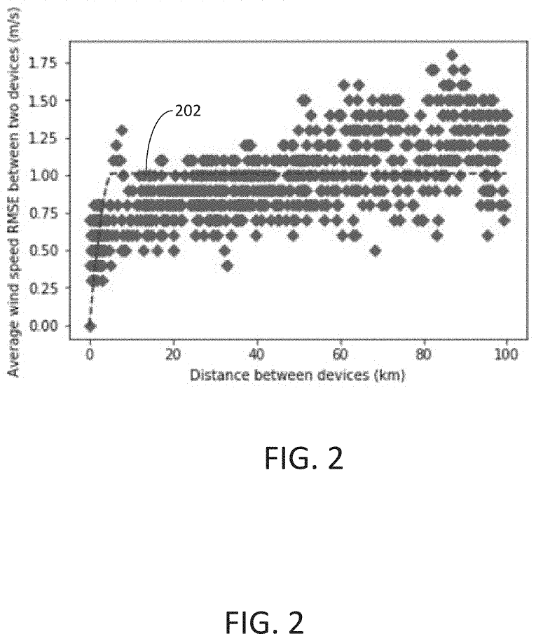

FIG. 2 illustrates one example of an observed RMSE for average wind speed between two weather sensing devices with respect to distances between the two weather sensing devices. The curve line 202 is a fitted line representing Eq. 1 from the RMSEs calculated among the weather sensing devices at various distances. From the line 202, if a desirable RMSE is selected, an optimal distance (density) for positioning the weather sensing devices can be determined. Other desirable distances for other weather variables may be similarly determined to the example shown in FIG. 2.

### Determine the Density of the Weather Station Network Based on Camera Coverage

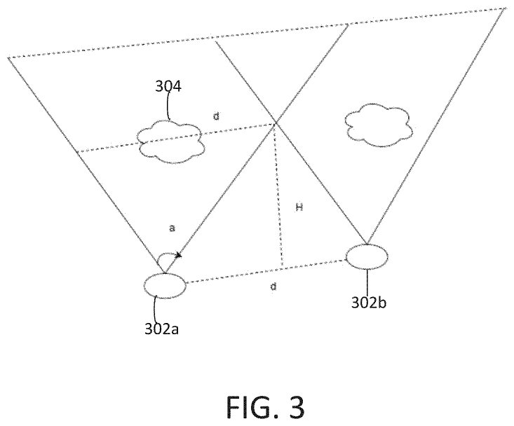

As mentioned above, a newer generation of weather sensing devices can include a high resolution camera for capturing the sky images or weather phenomenon images. Another insight provided by the inventor(s) is that: in order to cover a specific area without too much area omitted using multiple cameras, the observed object's distance to the camera can be used to determine an appropriate distance between the cameras. FIG. 3 shows an example of observing clouds using two cameras. In FIG. 3, two camera's coverage—i.e., that of camera 302a and 302b—is illustrated. The cameras 302a and 302b can be included (onboard) two different weather sensing devices, and provide image information in addition to the weather variables collected by the sensors. Capturing sky images to obtain the cloud change and movement is an important application of the weather sensing devices since cloud is associated with the weather systems and the examination of the clouds gives information on local weather system's change in a scale that the numerical weather models can't resolve.

As shown in FIG. 3, a cloud 304 is at a height H, which may range from a few hundred meters to a few kilometers. As also shown in FIG. 3, when the camera 302a captures the cloud 304 on the image plane, the diameter of the camera 302's coverage circle can be calculated using Eq. 2:

$${d}_{i} = 2 H tan ( \frac{a}{2} ) \text{\textbar} \qquad Eq . 2$$

In the Eq. 2 above, a is the camera observation angle. Thus, as can be seen, the diameter of the camera 302a's coverage circle can be equal to the distance dᵢ between two cameras (302a and 302b) given the cameras' observation angle are the same. Using this method, the distance between two adjacent cameras can be determined.

### Improved Determination Density for a Weather Sensing Device Network

In the above, two different approaches for determining the distance between any two weather sensing devices in an observation network are provided. One is based on 1) the continuity characteristics of the atmospheric variables and 2) the difference between weather variables at any two geophysical points increases with the distance between the two points and 3) the relationship can be described following Eq. 1. Another is based on a recent innovation of the weather station design, i.e., with the high resolution camera added to the traditional weather stations with only sensors and the distance between the two adjacent cameras can be determined based on the objects observed in the camera, or more precisely speaking the observed object's distance to the camera. In some embodiments, using the information obtained (e.g., from weather sensing devices shown in FIG. 1), appropriate density or a desirable distance between any two weather sensing devices in the observation network can be computed using Eq. 3

d=min{dₜ,dₕ,dₚ,d_{w},dᵣ,dᵢ} Eq. 3

In equation 3, a desirable distance between any two weather sensing devices may be selected from a set of distances calculated for weather variables such as temperature (dₜ), humidity (dₕ), pressure (dₚ), wind speed (d_{w}), rainfall (dᵣ), image distance (dᵢ)

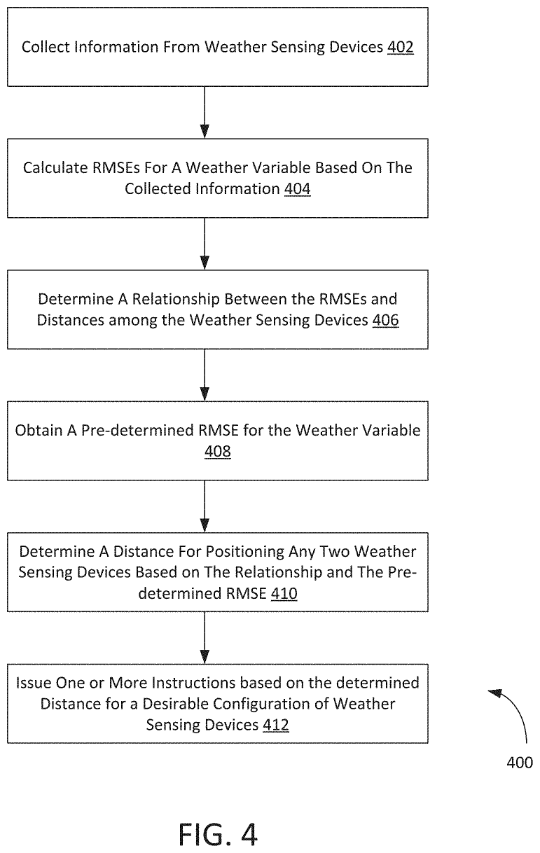

FIG. 4 illustrates an example method 400 for determining a desirable distance between two weather sensing devices in an observation network in accordance with the disclosure. It will be described with reference to FIGS. 1-3. The operations of method 400 presented below are intended to be illustrative. In some embodiments, method 400 may be accomplished with one or more additional operations not described and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 402, information can be collected from weather sensing devices already deployed on one or more fields. As shown in FIG. 1, weather sensing devices in various embodiments are already deployed on the one or more fields. These weather sensing devices can be configured to capture information such as weather information regarding temperature, humidity, pressure, wind speed, rainfall and/or any other weather variables in a particular portion of a field. In some embodiments, the information can include images covering various portions of the sky as shown in FIG. 3. Such information is generally referred to as time series—for a particular weather sensing device may capture such information over the time.

At operation 404, RMSEs can be calculated for a weather variable based on the information collected at 402. As mentioned above, for a particular weather variable such as wind speed, RMSEs can be calculated based on various distances among the weather sensing devices. For example, time series of a first weather sensing device may be compared with time series of a second weather sensing device to determine a first RMSE for the wind speed representing an error when the distance between two weather sensing devices is such between the first and second weather sensing devices. Similarly, a second RMSE can be calculated between the first weather sensing device and a third weather sensing device; a third RMSE can be calculated between the second weather sensing device and the third weather sensing device; and the like. An example of such calculated RMSEs is shown in FIG. 2.

It should be understood operation 404 may be an on-going operation such that it may be repeatedly performed regularly or non-regularly. For example, in one example configuration, the RMSE calculations may be performed nightly such that they account for daily collection of information by the weather sensing devices. In some other examples, the RMSE calculation may be manually performed by an operator of the observation network to account for information collected by the weather sensing devices since last time the RMSE calculation was performed.

At operation 406, a relationship between the RMSEs and the various distances among the weather sensing devices can be determined. As mentioned above, such a relationship should indicate a change of RMSE for a weather variable is proportion to a change of distance between two weather sensing devices in the observation network. In various embodiments, Eq. 1 shown above is used to determine such a relationship. As also mentioned above, the relationship can be expressed as Eq. 1 and may be determined by fitting a curve line using the RMSEs calculated at 404. FIG. 2 illustrates an example for fitting the curve to determine a relationship between average wind speed RMSE, and distances between two weather sensing devices. It should also be understood that operation 406 may be performed regularly or non-regularly. For example, it may be performed after new RMSEs are calculated at operation 404.

At operation 408, a desirable RMSE obtained for the weather variable. As explained above, the desirable RMSE may be a design choice depending on an application scenario for the observation network. This design choice may in turn depend on one or more objectives to be achieved by the observation network. For example, in a scenario where an objective is to accurately predict rainfall such that the error of prediction should be within 10 mm, the pre-determined RMSE should reflect such. On the other hand, if the rainfall prediction is not required to be as accurate, the pre-determined RMSE may be a little larger. In example implementations, the pre-determined RMSE can be obtained from a graphical user interface where a user or an administrator may provide the pre-determined RMSE. In some embodiments, the pre-determined RMSE can be automatically obtained from specification of the observation network.

At operation 410, a desirable distance for positioning any two weather sensing devices in the observation network can be determined based on the relationship determined at 406 and the desirable RMSE obtained at 408. For example, after the line is fit as shown in FIG. 2, for a particular desirable RMSE, a distance between any two weather sensing devices can be found on the line corresponding to the desirable RMSE. This distance can then be used to position weather sensing devices already deployed and/or will be deployed.

At operation 412, one or more instructions can be issued based on the desirable distance determined at 410. For example, the desirable distance determined at 410 may be 100 meter, and the current average distance between weather sensing devices already deployed is 150 meter. In this case, an instruction can be issued to reposition the already deployed weather sensing devices such that their distances are within 100 meter from each other and another instruction can be issued to indicate an amount of additional weather sensing devices needed to cover the field based such a desired density.

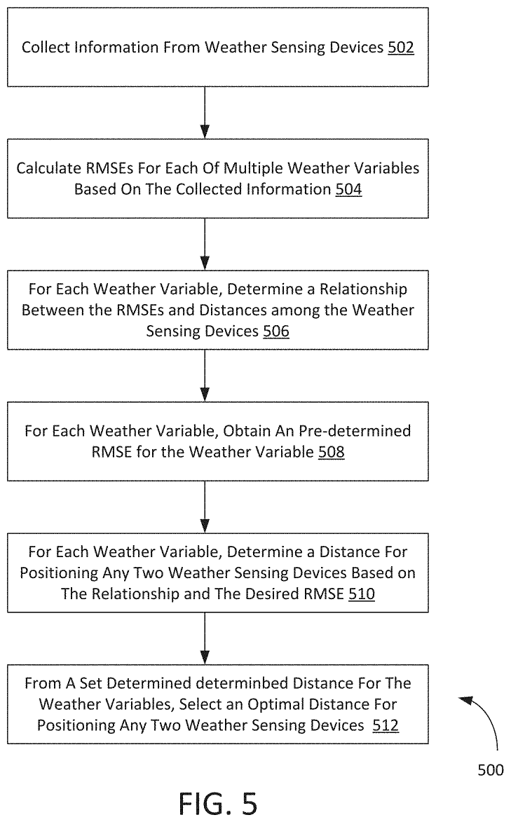

FIG. 5 illustrates another example method 500 for determining a desirable distance between two weather sensing devices in an observation network in accordance with the disclosure. It will be described with reference to FIGS. 1-4. The operations of method 500 presented below are intended to be illustrative. In some embodiments, method 500 may be accomplished with one or more additional operations not described and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

Operation 502 is similarly performed as operation 402. Please refer to operation 402 for more details.

At operation 504, in comparison with operation 404, RMSEs for multiple weather variables may be calculated. For example, a first set of RMSEs may be calculated for temperature; a second set of RMSEs may be calculated for humidity; a third set of RMSEs may be calculated for pressure; a fourth set of RMSEs may be calculated for wind speed; and/or a fifth set of RMSEs may be calculated for rainfall. For details of calculating a particular set of RMSEs for a particular weather variable, please refer to details provided at 404. It should be understood operation 504 may be performed regularly and/or non-regularly as described above with respect to operation 404.

At operation 506, for each weather variable, a relationship between the RMSEs and distances among the weather sensing devices can be determined. For example, a first relationship between the RMSES for temperature and distances can be determined; a second relationship between the RMSES for humidity and distances can be determined; a third relationship between the RMSEs for pressure and distances can be determined; a fourth relationship between the RMSEs for wind speed and distances can be determined; and/or a fifth relationship between the RMSEs for rainfall and distances can be determined. For details of calculating a particular relationship between RMSEs for a particular weather variable and distances among weather sensing devices, please refer to details provided at 406. It should be understood operation 506 may be performed regularly and/or non-regularly as described above with respect to operation 406

At operation 508, for each weather variable, a desirable distance for positioning any two weather sensing devices may be determined based on the relationship determined at 506 and an RMSE desirable for that weather variable. For example, a first desirable distance may be determined based on the first relationship and an RMSE desirable for temperature; a second desirable distance may be determined based on the second relationship and an RMSE desirable for humidity; a fourth desirable distance may be determined based on the fourth relationship and an RMSE desirable for wind speed; and/or a fifth desirable distance may be determined based on the fifth relationship and an RMSE desirable for rainfall. For details of determining a particular desirable distance for a particular weather variable, please refer to details provided at 508.

At operation 510, based on the set of desirable distances determined at 508, an optimal distance may be determined for positioning any two weather sensing devices in the observation network. For example, the optimal distance may be a minimum value in the set of desirable distances determined at 508.

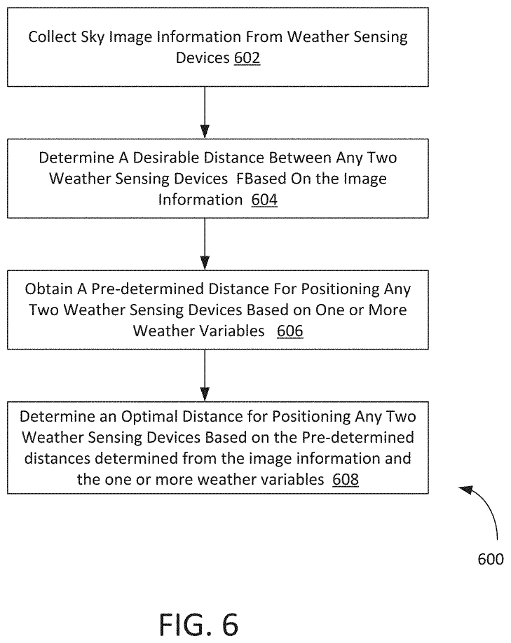

FIG. 6 illustrates still another example method 600 for determining a desirable distance between two weather sensing devices in an observation network in accordance with the disclosure. It will be described with reference to FIGS. 1-5. The operations of method 600 presented below are intended to be illustrative. In some embodiments, method 600 may be accomplished with one or more additional operations not described and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At operation 602, images captured by cameras onboard weather sensing devices deployed on one or more fields can be collected. As mentioned above, a newer generation of weather sensing devices are typically equipped with cameras. These cameras can be pointed at certain angles to capture portions of the sky over the time. These images can be collected at 602 for example by the system 100 shown in FIG. 1

At operation 604, a desirable distance between any two weather sensing devices may be determined based on the image information collected at 602. For example, in various embodiments, imaging processing may be performed on the images collected at 602 to determine the height of a cloud captured in the images. This height can then be used in those embodiments according to Eq. 2 to determine a desirable distance between two weather sensing devices for an optimal coverage of the sky.

At operation 606, a desirable distance for positioning any two weather sensing devices based on one or more weather variables can be obtained. For details of operations involved in 606, please refer to FIG. 4 and/or FIG. 5.

At operation 608, an optimal distance for positioning any two weather sensing devices may be determined based on the distance obtained at 604 and the distance obtained 606. For example, in example implementations, the optimal distance determined at 608 may be a minimum value between the distances obtained at 604 and 606.

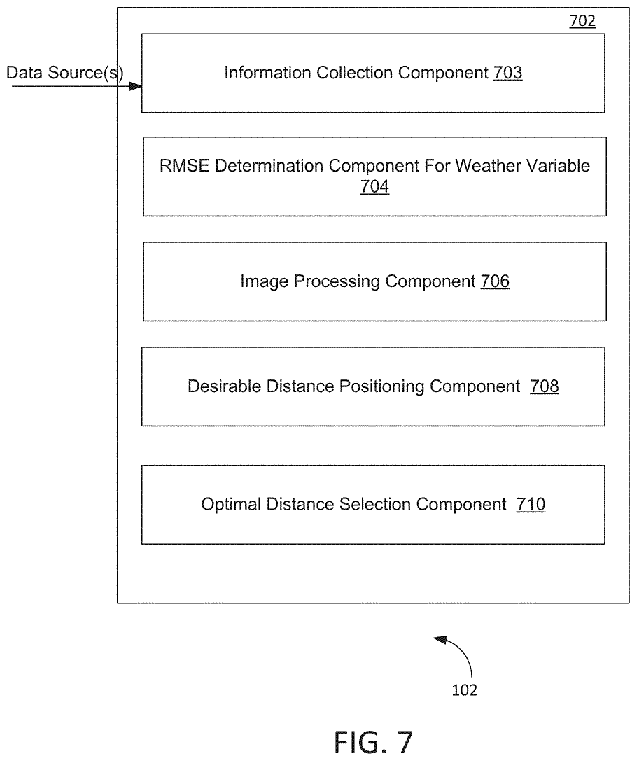

FIG. 7 illustrates one example for the server 102 shown in FIG. 1. It will be described with reference to FIGS. 1-6. As shown, the example server 102 shown in FIG. 7 may include one or more of a processor 702 configured to execute one or more computer program components including an information collection component 703, RMSE determination component for weather variable 704, image processing component 706, desirable distance positioning component 708, optimal distance selection component 710, and/or any other components.

The information collection component 703 can be configured to collect information from various weather sensing devices deployed on one or more fields and/or other data sources (e.g., a data source for providing historical weather data covering various fields). The information collected by information collection component 703 can include weather information, sky image information, field topology information, field condition information, and/or any other information. The field topology information can include geographical coordinates describing a particular field, an altitude of the field, location information regarding the field and/or any other topology information regarding the field. The field condition information can include information regarding soil condition on a field (e.g., average PH value for field soil), one or more objects (e.g., houses, man-made obstacles) on the field, one or more land features on the field (e.g., lakes, hills, streams, etc.), and/or any other field condition information.

The RMSE determination component for weather variable 704 can be configured to determine a set of RMSEs for a particular weather variable based on weather information collected by information collection component 703 over time. In some embodiments, exemplary implementation of RMSE determination component for weather variable 704 may include operations described and illustrated at 404 and 504.

The image processing component 706 may be configured to process image information collected by information collection component 703. For example, this may involve determining a height of a cloud in an image captured by a particular weather sensing device. In some embodiments, exemplary implementation of image processing component 706 may include operations described and illustrated at 604.

The image processing component 706 can be configured to combine the images captured by the optical sensors to generate wide-view sky images. This may involve receiving a command or instruction indicating a point of time and a sky portion for which a wide-view sky image is desired. For example, by way of illustration, the instruction may indicate a specific time (e.g. 6:03 pm this evening), and a center location of a sky, a shape and a size of the sky centering on this location.

The operations by the image processing component 706 may involve image stitching operations to combine related sky images captured by the optical sensors for a particular sky portion, such as the sky portion. Such stitching may involve retrieving relevant images from the storage and combining them according to geometrical relationships among them. For example, by way of illustration, for stitching a wide-view image of the sky portion at a given point of time, the image processing component 706 may first identify the capture grid network corresponding to the sky portion. As mentioned above, such an identification can be facilitated through the associations managed by the grid network management component 402. In this example, identification of the capture grid network 100 can be obtained as being corresponding to the sky portion.

The desirable distance positioning component 708 can be configured to determine one or more desirable distances for positioning weather sensing devices in an observation network. For example, the desirable distance positioning component 708 can be configured to determine such desirable distances based on desirable RMSE for temperature, humidity, pressure, wind speed, rainfall, sky image coverage, and/or any other factors. In some embodiments, exemplary implementation of image processing component 706 may include operations described and illustrated at 406, 408, 410, 506, 508, 510 and 606.

The optimal distance selection component 710 can be configured to determine an optimal distance for positioning any two weather sensing devices in the observation network based on the one or more desirable distances determined by desirable distance positioning component 708. For example, exemplary implementation of image processing component 706 may include operations described and illustrated at 512 and 608.

### Application Examples

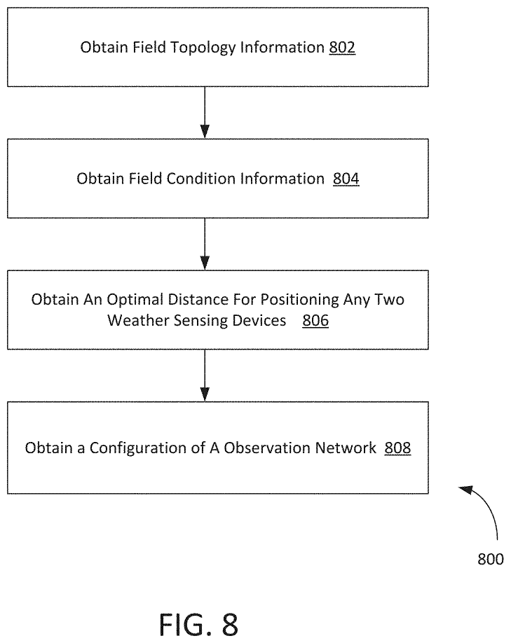

FIG. 8 illustrates an example of an application scenario of an optimal distance determined for positioning weather sensing devices in an observation network in accordance with the disclosure. It will be described with reference to FIGS. 1-7. The operations of method 800 presented below are intended to be illustrative. In some embodiments, method 800 may be accomplished with one or more additional operations not described and/or without one or more of the operations discussed. Additionally, the order in which the operations of method 800 are illustrated in FIG. 8 and described below is not intended to be limiting.

In some embodiments, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

At operation 802, field topology information may be obtained. As mentioned above, the field topology information obtained at 802 may include geographical coordinates of the field, a shape of the field, one or more altitudes of the field, and/or any other information. In implementations, such information may be obtained from various data sources such as an operator of the field, an agency providing land survey information, and/or any other sources.

At operation 804, field condition information may be obtained. As mentioned above, the field condition information obtained at 804 can include information regarding soil condition on a field (e.g., average PH value for field soil), one or more objects (e.g., houses, man-made obstacles) on the field, one or more land features on the field (e.g., lakes, hills, streams, etc.), and/or any other field condition information. In implementations, such information may be obtained from various data sources such as an operator of the field, an agency providing land survey information, and/or any other sources.

At operation 806, an optimal distance for positioning any two weather sensing devices in an observation network covering the network may be obtained. Please refer to FIGS. 4-6 for more details regarding operations that may be involved in 806.

At operation 808, a configuration of the observation network may be obtained. In some embodiments, this may involve presenting a graphical interface to a user; and in the interface, the field may be graphically presented and as well as various variables regarding the field. Such an interface can enable the user to configure the observation network. For instance, after the user places (virtual) a first weather sensing device in the field presented in the interface, a distance restraint may be imposed on the placement on the second weather sensing device in the field such that the second weather sensing device has to be within the distance obtained at 806. Other constraints may include no placement of weather sensing devices in certain land features such as lake/stream/river in the field, no placement of weather sensing devices on a roof of a house at an edge of the field, and so on. In some implementations, the placement of the weather sensing devices may be automatically determined and suggested to the user. For example, in the case where the field is a diamond shape, the placement may be automatically determined such that each weather sensing device will be placed on the vertices of the diamond and a center of the diamond. Other configurations are contemplated.

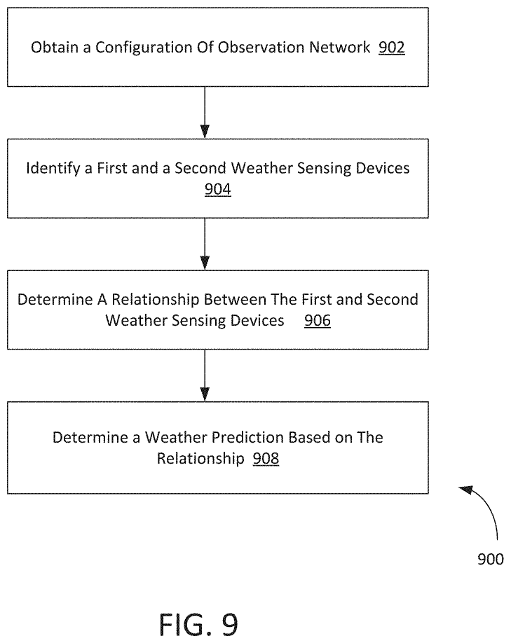

FIG. 9 illustrates another example of an application scenario of an optimal distance determined for positioning weather sensing devices in an observation network in accordance with the disclosure. The operations of method 900 presented below are intended to be illustrative. In some embodiments, method 900 may be accomplished with one or more additional operations not described and/or without one or more of the operations discussed. Additionally, the order in which the operations of method 900 are illustrated in FIG. 9 and described below is not intended to be limiting.

In some embodiments, method 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At an operation 902, a configuration and observation network can be obtained. Please refer to FIG. 8 for more details of 902.

At an operation 904, a first and a second weather sensing devices may be identified in the configuration obtained at 902. For example, in the example of an diamond shape of a field above, the first weather sensing device may be a device placed at a center of the diamond, and the second weather sensing device may be a device placed at the top vertex of the diamond. This is described merely for illustration. In implementations, any two weather sensing devices in the configuration can be identified as the first or second weather sensing devices.

At an operation 906, information collected by the first and second weather sensing devices can be analyzed and a relationship between the first and second weather sensing devices can be determined based on the analysis. For example, time series collected by the first and second weather sensing devices can be analyzed to determine RMSE for one or more weather variables (for example wind speed). This RMSE can be a relationship between the two weather sensing devices with respect to wind speed.

At an operation 908, the relationship determined at 906 between the first and second weather sensing devices can be used to make a weather prediction. For example, since the RMSE for the wind speed is known, and relative positions between the two devices is also known, when a wind speed is detected at the first weather sensing device and the wind going towards the second weather sensing device, a weather prediction can be made for the portion of filed in between the first and second weather sensing devices based on the RMSE determined at 906.

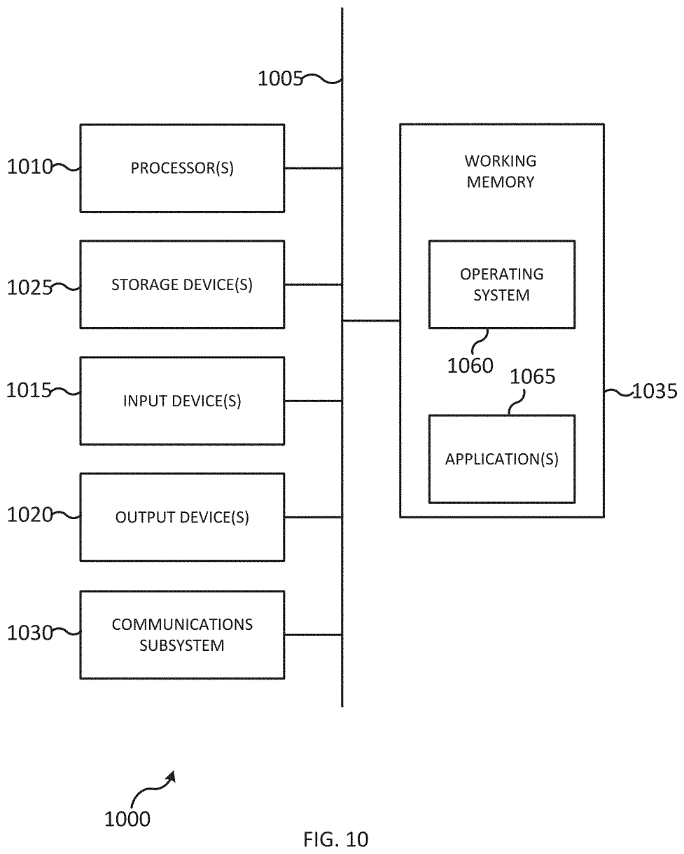

FIG. 10 illustrates a simplified computer system that can be used to implement various embodiments described and illustrated herein. A computer system 1000 as illustrated in FIG. 10 may be incorporated into devices such as a portable electronic device, mobile phone, or other device as described herein. FIG. 10 provides a schematic illustration of one embodiment of a computer system 1000 that can perform some or all of the steps of the methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005, or may otherwise be in communication, as appropriate. The hardware elements may include one or more processors 1010, including without limitation one or more general-purpose processors and/or one or more special-purpose processors such as digital signal processing chips, graphics acceleration processors, and/or the like; one or more input devices 1015, which can include without limitation a mouse, a keyboard, a camera, and/or the like; and one or more output devices 1020, which can include without limitation a display device, a printer, and/or the like.

The computer system 1000 may further include and/or be in communication with one or more non-transitory storage devices 1025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device, and/or a chipset such as a Bluetooth™ device, an 1002.11 device, a WiFi device, a WiMax device, cellular communication facilities, etc., and/or the like. The communications subsystem 1030 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1030. In other embodiments, a portable electronic device, e.g. the first electronic device, may be incorporated into the computer system 1000, e.g., an electronic device as an input device 1015. In some embodiments, the computer system 1000 will further comprise a working memory 1035, which can include a RAM or ROM device, as described above.

The computer system 1000 also can include software elements, shown as being currently located within the working memory 1035, including an operating system 1060, device drivers, executable libraries, and/or other code, such as one or more application programs 10105, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 10, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1025 described above. In some cases, the storage medium might be incorporated within a computer system, such as computer system 1000. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1000 to perform methods in accordance with various embodiments of the technology. According to a set of embodiments, some or all of the procedures of such methods are performed by the computer system 1000 in response to processor 1010 executing one or more sequences of one or more instructions, which might be incorporated into the operating system 1060 and/or other code, such as an application program 10105, contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 and/or components thereof generally will receive signals, and the bus 1005 then might carry the signals and/or the data, instructions, etc. carried by the signals to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A method for determining a configuration of observation network comprising weather sensing devices, the method being implemented by a processor configured to execute machine-readable instructions, wherein the method comprises:
collecting information regarding the weather sensing devices;
calculating value differences for a weather variable based on the collected information;
determining a relationship among the value differences and distances among the weather sensing devices;
obtaining a pre-determined value difference for the weather variable;
determining a distance for positioning two weather sensing devices in the observation network based on the relationship and the pre-determined value difference; and
issuing one or more instructions based on the determined distance for the configuration of the observation network.

2. The method of claim 1, wherein the weather variable includes one of the following: temperature, humidity, pressure, or wind speed.

3. The method of claim 1, wherein calculating the value differences for the weather variable comprises: calculating root-means-square errors (RMSEs) among values of the weather variable collected by the weather sensing devices, and wherein the desired value difference obtained in a pre-determined RMSE for the weather variable.

4. The method of claim 3, wherein determining the relationship among the RMSEs comprises:
fitting values of the RMSEs to a curve line; and
finding a coefficient for the curve line.

5. The method of claim 4, wherein the fitting of the values of the RMSEs to the curve line is according to e=α×d^{β}, wherein e represents a predicted RMSE between given two weather sensing devices based on a given distance between the given two weather sensing devices.

6. The method of claim 5, wherein determining the desirable distance for positioning two weather sensing devices in the observation network comprises:
obtaining a distance corresponding to the pre-determined RMSE on the curve as the desired distance.

7. The method of claim 3, wherein calculating the root-mean-square errors (RMSEs) for the weather variable based on the collected information comprises:
calculating a RMSE between a first and a second weather sensing devices in the observation network, the RMSE reflecting a root-mean square error between values of the weather variables observed by the first and second weather sensing devices over a time period.

8. The method of claim 1, wherein the information regarding the weather sensing devices includes at least one of the following: field topology information regarding a field corresponding to the observation network, or field condition information regarding a condition of the field.

9. The method of claim 8, wherein the information the determination of the desirable distance for positioning two weather sensing devices in the observation network is further based on the field topology information and/or the field condition information.

10. The method of claim 1, further comprising:
identifying a first and a second weather sensing devices;
determining a relationship between the first and second weather sensing devices; and
determining a weather prediction based on the relationship between the first and second weather sensing devices.

11. A system for determining a configuration of observation network comprising weather sensing devices, the system comprising a processor configured to execute machine-readable instructions such that when the machine-readable instructions are executed, the process is caused to perform:
collecting information regarding the weather sensing devices;
calculating value differences for a weather variable based on the collected information;
determining a relationship between the value differences and distances among the weather sensing devices;
obtaining a pre-determined value difference for the weather variable;
determining a desirable distance for positioning two weather sensing devices in the observation network based on the relationship and the pre-determined value difference; and
issuing one or more instructions based on the determined distance for the configuration of the observation network.

12. The system of claim 11, wherein the weather variable includes one of the following: temperature, humidity, pressure, or wind speed.

13. The system of claim 11, wherein calculating the value differences for the weather variable comprises: calculating root-means-square errors (RMSEs) among values of the weather variable collected by the weather sensing devices, and wherein the desired value difference obtained in a pre-determined RMSE for the weather variable.

14. The system of claim 13, wherein determining the relationship among the RMSEs comprises:
fitting values of the RMSEs to a curve line; and
find a coefficient for the curve line.

15. The system of claim 14, wherein the fitting of the values of the RMSEs to the curve line is according to e=α×d^{β}, wherein e represents a predicted RMSE between given two weather sensing devices based on a given distance between the given two weather sensing devices.

16. The system of claim 15, wherein determining the desirable distance for positioning two weather sensing devices in the observation network comprises:
obtaining a distance corresponding to the pre-determined RMSE on the curve as the desired distance.

17. The system of claim 13, wherein calculating the root-mean-square errors (RMSEs) for the weather variable based on the collected information comprises:
calculating a RMSE between a first and a second weather sensing devices in the observation network, the RMSE reflecting a root-mean square error between values of the weather variables observed by the first and second weather sensing devices over a time period.

18. The system of claim 11, wherein the information regarding the weather sensing devices includes at least one of the following: field topology information regarding a field corresponding to the observation network, or field condition information regarding a condition of the field.

19. The system of claim 18, wherein the information the determination of the desirable distance for positioning two weather sensing devices in the observation network is further based on the field topology information and/or the field condition information.

20. The system of claim 10, wherein the processor is further caused to perform:
identifying a first and a second weather sensing devices;
determining a relationship between the first and second weather sensing devices; and
determining a weather prediction based on the relationship between the first and second weather sensing devices.
